(19) United States
(12) Patent Application Publication
(10) Pub. No.: US 2013/0070390 A1
(43) Pub. Date: Mar. 21, 2013

(54) ELECTRODE ACTIVE MATERIAL, METHOD FOR PREPARING THE SAME, AND ELECTROCHEMICAL CAPACITOR INCLUDING THE SAME

(71) Applicants: Sang Kyun Lee, Gyeonggi-do (KR); Ji Sung Cho, Gyeonggi-do (KR); Bae Kyun Kim, Gyeonggi-do (KR)

(72) Inventors: Sang Kyun Lee, Gyeonggi-do (KR); Ji Sung Cho, Gyeonggi-do (KR); Bae Kyun Kim, Gyeonggi-do (KR)

(73) Assignee: Samsung Electro-Mechanics Co., Ltd., Suwon (KR)

(21) Appl. No.: 13/605,072

(22) Filed: Sep. 6, 2012

(30) Foreign Application Priority Data
Sep. 19, 2011 (KR) 10-2011-0094142

(51) Int. Cl. H01G 9/04; B32B 5/16; H01G 9/035

(52) U.S. Cl. 361/504; 428/402

(57) ABSTRACT

An electrode active material having a partially crystalline structure in a fine area (short range), a method for preparing the same, and an electrochemical capacitor including the same. The electrode active material having a partially crystalline structure in a fine area (short range) can be prepared by performing heat treatment at a proper temperature. In a case where the electrode active material is used for an electrode of an electrochemical capacitor, the pores as well as the partially crystalline structure, of the electrode active material, can contribute to capacitance, and thus, energy density of the electrochemical capacitor can be significantly improved.

### CROSS REFERENCE(S) TO RELATED APPLICATIONS

This application claims the benefit under 35 U.S.C. Section 119 of Korean Patent Application Serial No. 10-2011-0094142, entitled “Electrode Active Material, Method for Preparing the Same, and Electrochemical Capacitor Including the Same” filed on Sep. 19, 2011, which is hereby incorporated by reference in its entirety into this application.

### BACKGROUND OF THE INVENTION

1. Technical Field

The present invention relates to an electrode active material, a method for preparing the same, and an electrochemical capacitor including the same.

2. Description of the Related Art

In recent, an electric double layer capacitor (EDLC) has been successfully developed in relation to environmental problems because it has excellent input and output characteristics and high cycle reliability, as compared with a secondary battery, such as a lithium ion secondary battery. For example, the electric double layer capacitor is a promising power-storage device, which stores main power and subsidiary power of electric vehicles or reproducible energy such as solar light, wind power, or the like.

In addition, the electric double layer capacitor is expected to be also utilized as a device capable of outputting large current for a short time in an uninterruptible power supply device which is increasingly demanded by information technology (IT).

This electric double layer capacitor has a structure where a separator inserted between a pair or a plurality of polarizable electrodes (cathode and anode) made of carbon materials, facing each other, is immersed in an electrolytic liquid. Here, charges are stored on an electric double layer formed at an interface between the polarizable electrode and the electrolytic liquid.

On the other hand, a capacitor using an electrolytic liquid containing lithium ions therein, that is, an asymmetric type electrochemical capacitor storage device is suggested for the purpose of further increasing energy density. In this electrochemical capacitor storage device containing lithium ions, the cathode and the anode are different from each other in materials or functions, and thus, an activated carbon is used as a cathode active material, and a carbon material capable of easily adsorbing or desorbing the lithium ions in a reversible way is used as the anode active material. In addition, a separator is inserted between the cathode and the anode, and the resultant structure is immersed in the electrolytic liquid containing a lithium salt. The electrochemical capacitor storage device is used while the lithium ions are previously adsorbed on the anode.

FIG. 1 shows an operating principle and a basic structure of an electric double layer capacitor. Referring to this, current collectors 10, electrodes 20, an electrolytic liquid 30, and a separator 40 are disposed from both sides.

The electrode 20 consists of an active material made of a carbon material having a large effective specific surface area, such as an activated carbon powder, an activated carbon fiber, or the like, a conductive agent for imparting conductivity, and a binder for providing a binding force between respective components. In addition, the electrodes 20 include a cathode 21 and an anode 22 with a separator 40 therebetween.

In addition, as the electrolytic liquid 30, aqueous electrolytic liquid and non-aqueous (organic) electrolytic liquid are used.

The separator 40 is made by using polypropylene, Teflon, or the like, and serves to prevent short circuits due to contact between the cathode 21 and the anode 22.

When voltage is applied to the EDLC at the time of charging, electrolytic ions 31a and 31b dissociated from surfaces of the respective cathode 21 and anode 22 physically absorb the counter electrodes to store electricity. At the time of discharging, the ions of the cathode 21 and the anode 22 desorbs from the electrodes, thereby returning to a neutralization state.

Meanwhile, a general electrochemical capacitor forms capacitance by electron behavior caused by absorption/desorption reactions of the ions of the electrolytic liquid on a surface of carbon material such as activated carbon.

Recently, there persistently occurs a demand for increasing capacitance per unit volume over whole application areas of small-sized/large-sized electrochemical capacitors because of size limitation.

A generally manufactured electrochemical capacitor has a structure where the same voltage is applied to the cathode and the anode, as shown in FIG. 2. At present, products of 2.7 to 2.8V level are known to realize the maximum voltage.

Therefore, most advantageously, the applied voltage is boosted to increase energy density, but the development of electrode materials in order to meet this demand has not been sufficient until now. For meeting this demand, there is a need of an electrode active material capable of realizing high voltage and an electrolytic liquid having a wide potential window, which is not oxidized even in a high-voltage region.

### SUMMARY OF THE INVENTION

An object of the present invention is to provide an electrode active material satisfying characteristics requested in increasing the voltage of an electrochemical capacitor, and enabling intercalation of electrolytic ions so as to increase the voltage of the electrochemical capacitor.

Another object of the present invention is to provide a method for preparing the electrode active material.

Still another object of the present invention is to provide an electrochemical capacitor including an electrode containing the electrode active material and an electrolytic liquid.

According to one exemplary embodiment of the present invention, there is provided an electrode active material having a partially crystalline structure where, among 100 particles randomly selected, the number of particles including crystal lattices of 0.33 to 0.38 nm size based on D002 plane is 5 or more.

The electrode active material may have a specific surface area of 1800 to 2500 m²/g.

The electrode active material may be at least one non-graphitizable material selected from the group consisting of a natural alicyclic compound and a synthetic polymer, activated carbon, carbon black, glass carbon, char, and coal.

The natural alicyclic compound and the synthetic polymer may be at least one selected from the group consisting of cycloalkane (CₙH₂ₙ), cycloalkene (CₙH₂ₙ₋₂), and cycloalkyne (CₙH₂ₙ₋₄).

According to another exemplary embodiment of the present invention, there is provided an electrode active material prepared through heat treatment at 900 to 1500° C. characterized by having a partially crystalline structure where, among 100 particles randomly selected, the number of particles including crystal lattices of 0.33 to 0.38 nm size based on D002 plane is 5 or more.

According to still another exemplary embodiment of the present invention, there is provided an electrochemical capacitor, including: an electrode containing the electrode active material; and an ionic electrolytic liquid.

The ionic electrolytic liquid may contain at least one selected from the group consisting of Br⁻, BF₄⁻, and TFSI⁻ as an anion and at least one selected from the group consisting of 1,3-dialkylimidazolium, N-alkylpyridinium, and tetra-alkylphosphonium as a cation.

The electrode may be any one selected from a cathode and an anode, or both thereof.

When the electrode is the cathode, the maximum voltage of the cathode may be kept up to 4.5V.

The electrochemical capacitor may further include an organic electrolytic liquid together with the ionic electrolytic liquid.

### BRIEF DESCRIPTION OF THE DRAWINGS

FIG. 1 shows a basic structure and an operating principle of a general electric double layer capacitor;

FIG. 2 shows voltage regions of the general electrochemical capacitor and behavior of voltage applied to the cathode/anode;

FIGS. 3 and 4 are transmission electron microscope (TEM) pictures of a crystal phase structure existing in a fine area (short range) of activated carbons prepared according to Examples 1 and 2; and

FIG. 5 is a graph showing a voltage range of an electrochemical capacitor using the electrode active material, which is prepared according to Example 1 of the present invention.

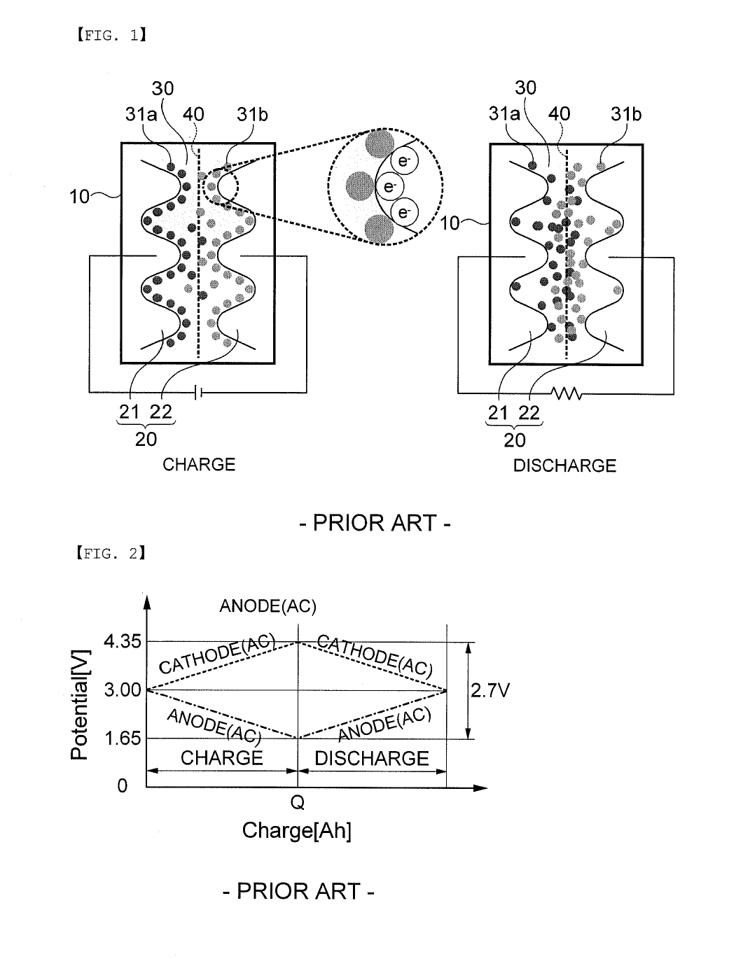

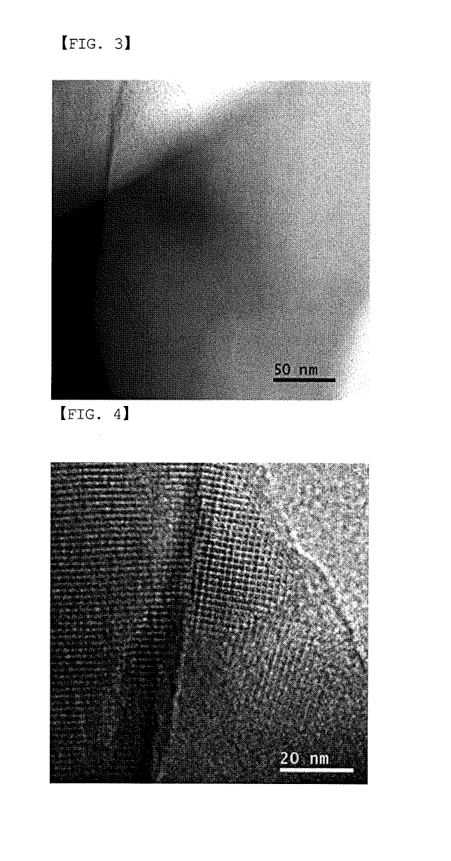

### DESCRIPTION OF THE PREFERRED EMBODIMENTS

Hereinafter, the present invention will be described in more detail.

Terms used in the present specification are for explaining the embodiments rather than limiting the present invention. Unless explicitly described to the contrary, a singular form includes a plural form in the present specification. Also, used herein, the word “comprise” and/or “comprising” will be understood to imply the inclusion of stated constituents, steps, operations and/or elements but not the exclusion of any other constituents, steps, operations and/or elements.

The present invention relates to an electrode active material, a method for preparing the same, and an electrochemical capacitor including the same.

An electrode active material according to one exemplary embodiment of the present invention is characterized by having a partially crystalline structure, according to which, among 100 particles randomly selected, the number of particles including crystal lattices of 0.33 to 0.38 nm sizes based on D002 plane is 5 or more.

In the present invention, the randomly selected particle used for determining the partially crystalline structure is not particularly limited as long as the crystal lattice can be confirmed, and a transmission electron microscope (TEM) is used.

The electrode active material used for the electrochemical capacitor is mainly activated carbon until now, and the activated carbon has an amorphous phase not containing a crystalline structure.

In the present invention, by properly regulating the temperature for heat treatment of a material containing only the amorphous phase, a material where crystal phases locally exist in a fine area (short range) of sub-micrometer, for example, 0.33 to 0.38 nm size, is used as the electrode active material.

As the electrode active material according to the present invention, at least one non-graphitizable material selected from a group consisting of a natural alicyclic compound and a synthetic polymer, activated carbon, carbon black, glass carbon, char, and coal is preferably used, and the activated carbon is most preferable among these.

Examples of the natural alicyclic compound and the synthetic polymer may be at least one selected from a group consisting of cycloalkane (CₙH₂ₙ) formed by only single bonds, cycloalkene (CₙH₂ₙ₋₂) having a double bond in a ring thereof, and cycloalkyne (CₙH₂ₙ₋₄) having a triple bond, but is not limited thereto.

In addition, preferably, the electrode active material according to the present invention has a partially crystalline structure in a fine area (short range) and has a porous structure having many pores formed thereof. For achieving this, preferably, the electrode active material according to the present invention has a specific surface area of 1800 to 2500 m²/g. If the specific surface area thereof deviates from the above range, too may fine pores are formed in the activated carbon, resulting in pores of the active material which does not substantially contribute to form capacitance.

The non-graphitizable materials are not easy to crystallize in a carbonization process, which is a heat treatment process carried out in order to be used the general electrode active material. Therefore, in order to prepare an electrode active material having a partially crystalline structure, heat treatment at a specific temperature was performed, thereby preparing a material where crystal phases locally exist in a fine area (short range) of sub-micrometer, for example 0.33 to 0.38 nm size.

Therefore, in a method for preparing an electrode active material according to the present invention, heat treatment at 900-1500° C. is performed, so that the electrode active material has a sub-micrometer level of, for example, a partially crystalline structure, according to which, among 100 particles randomly selected by using TEM or the like, the number of particles including crystal lattices of 0.33 to 0.38 nm size based on D002 plane is 5 or more.

If the temperature for heat treatment is below 900° C., partial crystal phases are not sufficiently formed, and if above 1500° C., particle sizes of the active material are difficult to control.

When the material having a partially crystalline structure in a fine area (short range) is used as the electrode active material, electrolytic ions can be intercalated into the crystal structure, thereby expanding a voltage window.

As above, when the voltage window is expanded, an electrochemical capacitor having high energy density can be manufactured since the energy density is proportional to the voltage.

Further, the pores existing in an amorphous area in a surface of the electrode material contribute to capacitance and the partially crystallized area also contributes to capacitance, thereby high-capacitance electrochemical capacitor can be manufactured.

After heat treatment is performed on the electrode active material according to the present invention at a proper temperature, an activating procedure, such as, activation with steam, activation with melt KOH, or the like, may be involved. Processes after the heat treatment are performed according to the known methods, and the preparing method thereof is not particularly limited.

Meanwhile, when the operating voltage region is boosted because of using the electrode active material having the above characteristics, an electrolytic liquid, which is not oxidized at the voltage region, needs to be used.

For this reason, the present invention may employ an ionic electrolytic liquid having oxidation resistance at a high voltage region or other organic electrolytic liquid together with the ionic electrolytic liquid.

The ionic electrolytic liquid may contain at least one selected from the group consisting of Br⁻, BF₄⁻, and TFSI⁻ as an anion and at least one selected from the group consisting of 1,3-dialkylimidazolium, N-alkylpyridinium, and tetra-alkylphosphonium as a cation.

Specific examples thereof may include at least one selected from the group consisting of tetra-ethylamine-tetra fluoro borate (TEA-BF₄), spiro-bipyrrolidinium tetrafluoroborate-tetra fluoro borate (SBP-BF₄), and ethylmethyl imidazolium-tetra fluoro borate (EMI-BF₄).

Further, in addition to the ionic electrolytic liquid, at least one organic electrolytic liquid selected from the group consisting of propylene carbonate (PC), diethyl carbonate, ethylene carbonate (EC), sulfolane, acetone nitrile, dimethoxy ethane and tetrahydrofuran, and ethyl methyl carbonate (EMC) may be used, but is not limited thereto.

Further, in the present invention, an electrode having a current collector coated with an electrode active material slurry composition containing the electrode active material may be used as one selected from a cathode and/or an anode, or both thereof. A coating method of the electrode active material slurry composition is not particularly limited.

Further, a mixture of the electrode active material, the conducting agent, and the solvent may be molded in a sheet shape by using the binder resin, or a molded sheet extruded by an extrusion method may be attached to the current collector by using a conductive adhesive.

Further, a material used in the conventional electric double-layer capacitors or lithium ion batteries may be used for a cathode current collector. Examples of the material may be at least one selected from a group consisting of aluminum, stainless, titanium, tantalum, and niobium, and aluminum is preferable among these.

In addition, the thickness of the current collector may be about 10 to 300 μm. An example of the current collector may include a metal foil, an etched metal foil, or those having holes penetrating through front and rear surfaces thereof, such as an expanded metal, a punching metal, a net, foam, or the like.

Further, a material used in the conventional electric double-layer capacitors or lithium ion batteries may be used for an anode current collector. Examples of the material may include stainless, copper, nickel, or an alloy thereof, and copper is preferable among these. In addition, the thickness thereof may be about 10 to 300 μm. An example of the current collector may include a metal foil, an etched metal foil, or those having holes penetrating through front and rear surfaces thereof, such as an expanded metal, a punching metal, a net, foam, or the like.

An electrode active material slurry composition according to the present invention may contain the electrode active material, a conducting agent, a binder resin, and a solvent.

Examples of the conducting agent may include conductive powder of super-P, ketjen black, acetylene black, carbon black, graphite, or the like, but are not limited thereto. In other words, the examples of the conducting agent may include all kinds of conducting agents that can be used in general electrochemical capacitors.

Examples of the binder resin may include at least one selected from a fluorine based resin, such as polytetrafluoroethylene (PTFE), polyvinylidene fluoride (PVdF), or the like; a thermoplastic resin, such as polyimide, polyamideimide, polyethylene (PE), polypropylene (PP), or the like; a cellulose based resin, such as carboxymethylenecellulose (CMC) or the like; a rubber based resin, such as styrene-butadiene rubber (SBR) or the like; and a mixture thereof, but are particularly not limited thereto. Any binder resin that can be used for common electrochemical capacitors may be used.

As the separator according to the present invention, any material used in the conventional electric double-layer capacitor or lithium ion battery may be used, and, an example thereof may be a microporous film prepared from at least one polymer selected from the group consisting of polyethylene (PE), polypropylene (PP), polyvinylidene fluoride (PVdF), polyvinlylidene chloride, polyacrylonitrile (PAN), polyacrylamide (PAAm), polytetrafluoro ethylene (PTFE), polysulfone, polyethersulfone (PES), polycarbonate (PC), polyamide (PA), polyimide (PI), polyethylene oxide (PEO), polypropylene oxide (PPO), cellulose based polymer, and polyacryl based polymer. Also, a multilayer film obtained by polymerizing the microporous film may be used as the separator, and the cellulose based polymer may be preferably used among these.

Preferably, the separator has a thickness of 15 to 35 μm, but is not limited thereto.

A laminate film including aluminum, which is commonly used in a secondary battery and an electrical double layer capacitor, is preferably used as a case (an exterior part) of the electrochemical capacitor of the present invention, but particularly not limited thereto.

According to the exemplary embodiment of the present invention, when the electrode is a cathode, the maximum voltage of the cathode may be kept up to 4.5V. That is to say, the maximum voltage of the cathode was kept at about 4.35V in the related art, but the maximum voltage of the cathode can be expanded by using an electrode active material having a partially crystalline structure in the present invention.

Hereinafter, exemplary embodiments of the present invention will be described in detail. The following examples are only for illustrating the present invention, and the scope of the present invention should not be interpreted as being limited by these examples. In addition, specific compounds are used in the following examples, but it is obvious to those skilled in the art that equivalents thereof can exhibit the same or similar degrees of effects.

### Example 1

### Preparation of Electrode Active Material

Heat treatment was performed on activated carbon at 900° C. for 10 hours. Also, the heat-treated-activated carbon was activated by activation with steam, to obtain a carbon-based material (particle size: 5 to 20 μm) having a specific surface area of about 1800 to 2500 m²/g.

### Example 2

### Preparation of Electrode Active Material

Heat treatment was performed on activated carbon at 1200° C. for 5 hours. Also, the heat-treated-activated carbon was activated by activation with steam, to obtain a carbon-based material (particle size: 5 to 20 μm) having a specific surface area of about 1800 to 2200 m²/g.

### Experimental Example

### Determination of Structure

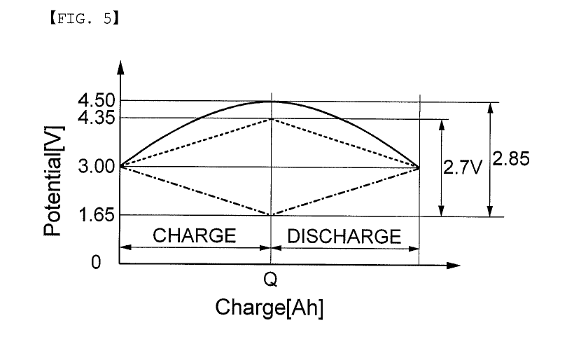

A transmission electron microscope confirmed a structure of the obtained activated carbon in Examples 1 and 2, and the results were shown in FIGS. 3 and 4.

It can be confirmed from FIGS. 3 and 4 that the electrode active material prepared according to the present invention is an activated carbon having a partially crystalline structure, where, among 100 particles randomly selected, the number of particles including crystal lattices of 0.33 to 0.38 nm size based on D002 plane is 5 or more, when measured by TEM.

### Example 3

### Manufacture of Electrochemical Capacitor

85 g of activated carbon having a partially crystalline structure, prepared in Example 1, 18 g of Super-P as a conductive agent, and 3.5 g of CMC, 12.0 g of SBR, and 5.5 g of PTFE as a binder, were mixed with 225 g of water, followed by mixing and stirring, thereby preparing an electrode active material slurry.

The electrode active material slurry was coated on an aluminum foil current collector using a comma coater, followed by temporary drying, and then cut into electrodes with a size of 50 mm×100 mm. The electrode had a cross-sectional thickness of 60 μm. The electrode was dried under vacuum at 120° C. for 48 hours, before a cell is assembled.

A separator (TF4035 from NKK, cellulose-based separator) was inserted between the prepared electrodes (cathode and anode), followed by impregnation with the ethylmethyl imidazolium-tetra fluoro borate (EMI-BF₄) as an ionic electrolytic liquid, and then the resulting structure was put and sealed in a laminate film case, thereby manufacturing an electric double layer capacitor.

### Experimental Example 2

### Measurement of Voltage

Voltage measurement was performed by charging the assembled cell to 3.1V at a rate of 100 C rate, which is then kept for 36 seconds under CV condition, and discharging it to a half of the level of the applied voltage at a rate of 100 C, and the results were tabulated in Table 1.

TABLE 1

| Cycle | Voltage conditions | | |
|---|---|---|---|
| number | 2.7 V | 2.9 V | 3.1 V |
| 1,000 | 99.8% | 99.8% | 99.6% |
| 5,000 | 99.6% | 99.3% | 99.1% |
| 10,000 | 99.5% | 99.0% | 98.8% |

As shown in results of Table 1, an equal level of capacity maintenance ratio was confirmed even at the 100 C rate cycle evaluation under the condition of increasing voltage. This means assurance of voltage stability, with the result that it could be confirmed that energy density was improved.

### Experimental Example 3

### Measurement of Voltage

The maximum voltage of the cathode was measured by using the assembled cell, and the results were shown in FIG. 5.

As shown in the results of FIG. 5, it could be confirmed that the maximum voltage of the cathode was kept at a high level of up to about 4.5V. The maximum voltage of the cathode was kept at about 4.3V in the related art, but the maximum voltage of the cathode can be expanded by using an electrode active material having a partially crystalline structure in the present invention.

According to the present invention, an electrode active material having a partially crystalline structure in a fine area (short range) can be prepared by performing heat treatment at a proper temperature. In a case where the electrode active material is used for an electrode of an electrochemical capacitor, the pores as well as the partially crystalline structure, of the electrode active material, can contribute to capacitance, and thus, energy density of the electrochemical capacitor can be significantly improved.

In addition, the improvement of energy density can boost the voltage range, which is proportional to the voltage, thereby meeting the demand for increasing capacitance per unit volume recently requested in small-sized/large-sized electrochemical capacitors, and thus, the present invention can be applied to various fields.

While the present invention has been shown and described in connection with the embodiments, it will be apparent to those skilled in the art that modifications and variations can be made without departing from the spirit and scope of the invention as defined by the appended claims.

What is claimed is:

1. An electrode active material having a partially crystalline structure where, among 100 particles randomly selected, the number of particles including crystal lattices of 0.33 to 0.38 nm size based on D002 plane is 5 or more.

2. The electrode active material according to claim 1, wherein the electrode active material has a specific surface area of 1800 to 2500 m²/g.

3. The electrode active material according to claim 1, wherein the electrode active material is at least one non-graphitizable material selected from the group consisting of a natural alicyclic compound and a synthetic polymer, activated carbon, carbon black, glass carbon, char, and coal.

4. The electrode active material according to claim 3, wherein the natural alicyclic compound and the synthetic polymer are at least one selected from the group consisting of cycloalkane (CₙH₂ₙ), cycloalkene (CₙH₂ₙ₋₂), and cycloalkyne (CₙH₂ₙ₋₄).

5. A method for preparing the electrode active material according to claim 1, comprising performing heat treatment at 900 to 1500° C.

6. An electrochemical capacitor, comprising:
an electrode containing the electrode active material according to claim 1; and
an ionic electrolytic liquid.

7. The electrochemical capacitor according to claim 6, wherein the ionic electrolytic liquid contains at least one selected from the group consisting of Br⁻, BF₄⁻, and TFSI⁻ as an anion and at least one selected from the group consisting of 1,3-dialkylimidazolium, N-alkylpyridinium, and tetra-alkylphosphonium as a cation.

8. The electrochemical capacitor according to claim 6, wherein the electrode is any one selected from a cathode and an anode, or both thereof.

9. The electrochemical capacitor according to claim 6, wherein when the electrode is the cathode, the maximum voltage of the cathode is kept up to 4.5V.

10. The electrochemical capacitor according to claim 6, further comprising an organic electrolytic liquid together with the ionic electrolytic liquid.
